(19) United States
(12) Patent Application Publication
(10) Pub. No.: US 2023/0198858 A1
(43) Pub. Date: Jun. 22, 2023

(54) MACHINE LEARNING MODEL-BASED, OVERHEAD LINE BREAKAGE PREDICTION SYSTEM

(71) Applicant: Kyndryl, Inc., New York, NY (US)

(72) Inventors: Tiberiu SUTO, Franklin, NY (US); Jessika Ann WELCH, Amesbury, MA (US)

(21) Appl. No.: 17/555,780

(22) Filed: Dec. 20, 2021

(51) Int. Cl. H04L 41/16

(52) U.S. Cl. CPC H04L 41/16

(57) ABSTRACT

Data analysis-based line breakage prediction is provided, which includes providing a machine learning model trained to, at least in part, facilitate minimizing downtime within a network that includes an overhead line. Tensile-related data for the overhead line is obtained, and the machine learning model analyzes relevant data for the overhead line, including the tensile-related data for the overhead line, and generates a probability of breakage score for the overhead line based on the relevant data, including the tensile-related data. An action is initiated, using the machine learning model, to minimize downtime within the network based, at least in part, on the generated probability of breakage score for the overhead line.

### BACKGROUND

Power delivery systems often include a transmission grid and a distribution grid with electric power being distributed through the grids via electrical lines. Depending on the location, a significant portion of the electrical lines can be overhead electrical lines exposed to ambient weather conditions.

Traditionally, weather has been the leading cause of electrical infrastructure disruption. Utilities expend significant time and money each year restoring power to customers. Also, lives can be at risk when the power goes out, and until power is restored. Society as a whole also suffers during a power outage, for instance, from business closures, productivity loss, traffic and public service disruption, to environmental impacts of temporary power generation.

### SUMMARY

Certain shortcomings of the prior art are overcome and additional advantages are provided through the provision, in one or more aspects, of a computer program product for facilitating processing within a computing environment. The computer program product includes at least one computer readable storage medium having program instructions embodied therewith. The program instructions are readable by a processing circuit to cause the processing circuit to perform a method, which includes providing a machine learning model trained to, at least in part, facilitate minimizing downtime within a network, where the network includes an overhead line. Further, the method includes obtaining tensile-related data for the overhead line, and analyzing, by the machine learning model, relevant data for the overhead line, including the tensile-related data for the overhead line. A probability of breakage score for the overhead line is generated by the machine learning model based on the relevant data, including the tensile-related data, and the method includes initiating, using the machine learning model, an action to minimize downtime within a network based, at least in part, on the generated probability of breakage score for the overhead line.

Computer systems and computer-implemented processes relating to one or more aspects are also described and claimed herein. Further, services relating to one or more aspects are also described and can be claimed herein.

Additional features and advantages are realized through the techniques described herein. Other embodiments and aspects of the invention are described in detail herein and are considered a part of the claimed aspects.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a computing environment incorporating and using one or more aspects of the present invention;

FIG. 2 depicts a further example of a computing environment to incorporate and use one or more aspects of the present invention;

FIG. 3 illustrates another example of a computing environment to incorporate and use one or more aspects of the present invention;

FIG. 4 depicts one embodiment of a workflow illustrating certain aspects of one or more embodiments of the present invention;

FIGS. 5A-5C depict one embodiment of a line sensor assembly, in accordance with one or more aspects of the present invention;

FIG. 6 is a schematic depiction of another embodiment of a line sensor assembly for use in a workflow in accordance with one or more aspects of the present invention;

FIG. 7A depicts an example of a computing environment to incorporate and use one or more aspects of the present invention;

FIG. 7B depicts further details of the memory of FIG. 7A, in accordance with one or more aspects of the present invention;

FIG. 8 depicts one embodiment of a cloud computing environment, in accordance with one or more aspects of the present invention; and

FIG. 9 depicts one example of abstraction model layers, in accordance with one or more aspects of the present invention.

### DETAILED DESCRIPTION

The accompanying figures, which are incorporated in and form a part of this specification, further illustrate the present invention and, together with the detailed description of the invention, serve to explain aspects of the present invention. Note in this regard that descriptions of well-known systems, devices, global positioning systems (GPS), processing techniques, etc., are omitted so as to not unnecessarily obscure the invention in detail. Further, it should be understood that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further, that numerous inventive aspects and features are disclosed herein, and unless inconsistent, each disclosed aspect or feature is combinable with any other disclosed aspect or feature as desired for a particular application of the concepts disclosed herein.

Note also that illustrative embodiments are described below using specific code, designs, architectures, protocols, layouts, schematics or tools, only as examples, and not by way of limitation. Further, the illustrative embodiments are described in certain instances using particular hardware, software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

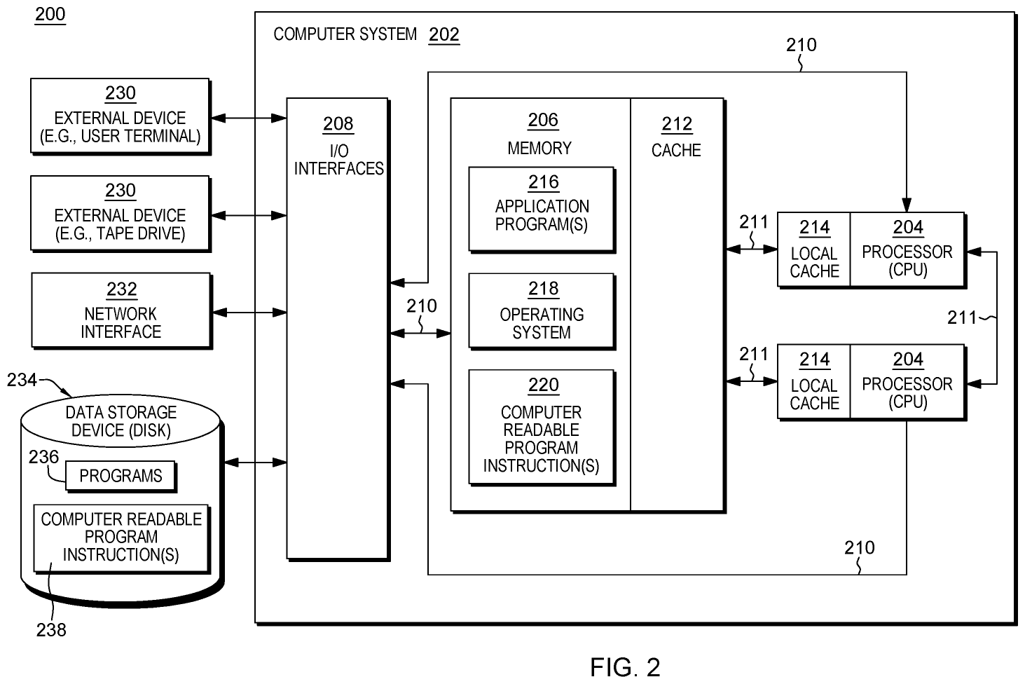

As understood by one skilled in the art, program code, as referred to in this application, can include both hardware and software. For example, program code in certain embodiments of the present invention can include fixed function hardware, but other embodiments can utilize a software-based implementation of the functionality described. Certain embodiments combine both types of program code. One example of program code, also referred to as one or more programs or program instructions, is depicted in FIG. 2 as one or more of application program(s) 216, and computer-readable program instruction(s) 220, stored in memory 206 of computing environment 200, as well as programs 236 and computer-readable program instruction(s) 238, stored in a data storage device 234 accessed by, or within, computing environment 200.

As noted, power delivery systems deliver electrical power through grids via electrical lines. Depending on the location, a significant portion of the electrical lines can be overhead electrical lines exposed to ambient weather conditions. Traditionally, weather has been a leading cause of electrical infrastructure disruption. When a power outage occurs, customers are negatively impacted, with data from various studies estimating the cost from storm-related outages in today's economy at between 20-55 billion dollars annually.

Outage prediction is not an automated process for most utilities today. Even more advanced utility providers using state of the art weather modeling to predict outages still have unplanned outages. This is because of the accuracy of current models is only about 70%.

As described herein, in one or more aspects, intelligent analytics is used to facilitate predicting a likelihood of line breakage, such as breakage of an electrical line. Advantageously, in one or more embodiments, the line breakage prediction facility, system and process disclosed herein provides a more accurate modeling of likely line breakage to, for instance, help utilities transition from power restoration to outage prevention. This is accomplished, in part, by providing a machine learning model which obtains data on the overhead line itself, which (in one or more embodiments) is combined with, for instance, current weather data and/or historical weather data, etc., to enhance prediction of the likelihood of breakage of an overhead line within, for instance, a specified time interval.

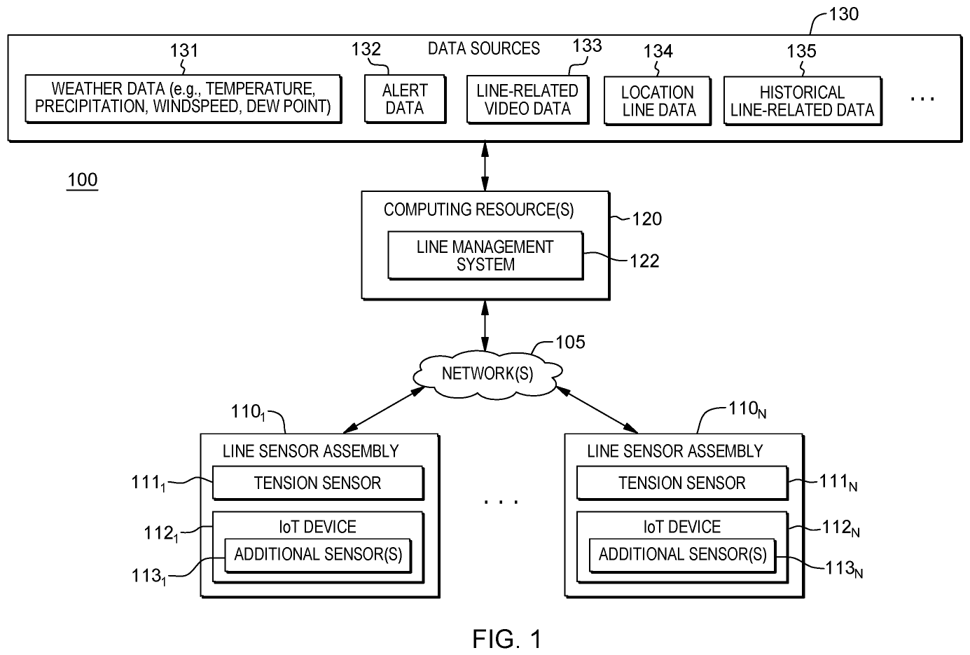

By way of example, FIG. 1 depicts one embodiment of a computing environment 100 to incorporate and use one or more aspects of the present invention. As illustrated, computing environment 100 includes one or more line sensor assemblies 110₁-110_{N} coupled to one or more overhead lines, such as one or more overhead electrical lines of a power grid. The line sensor assemblies are in communication across one or more networks 105 with one or more computing resources 120 which include, in one embodiment, a line management system 122 implemented processing in accordance with one or more embodiments of the present invention.

As one example, line sensor assemblies 110₁-110_{N} are each coupled at different locations to the same or different overhead lines to be monitored. In one or more embodiments, each line sensor assembly 110₁ . . . 110_{N} includes a respective tension sensor 111₁ . . . 111_{N} for sensing tensile strength of the overhead line at the location where the line sensor assembly is coupled to the overhead line, and for providing tensile-related data for evaluation by the data-analysis-based line, breakage prediction system. Each line sensor assembly 110₁-110_{N} can take a variety of forms. In one embodiment, one or more of the line sensor assemblies further includes one or more internet of things devices 112₁-112_{N}. In one embodiment, each internet of things device can include one or more additional sensors 113₁-113_{N}, such as one or more temperature sensors, humidity sensors, accelerometers, etc. As understood, each internet of things device can be, or include, for instance, an electronic device, such as a wireless electronic device, or a wired electronic device, with one or more sensors, processing ability, program code, and other technologies that connect and exchange data with other devices and/or systems such as other internet of things devices 112₁ . . . 112_{N} and/or line management system 122 of computing resource(s) 120. Note that a line sensor assembly as disclosed herein can have other components in addition to those described, including, for instance, an image capture component, a global positioning system (GPS) component, as well as other components as desirable to facilitate data-analysis-based line breakage prediction, such as described.

In one embodiment, line sensor assemblies 110₁ . . . 110_{N} communicate data across network(s) 105 to computing resource(s) 120 (such as one or more cloud-based computing resources) to facilitate implementing one or more aspects of a workflow, such as disclosed herein. For instance, in the embodiment of FIG. 1, computing resource(s) 120 includes a line management system 122 configured with artificial intelligence or a machine-learning based data analytics and prediction facility, in accordance with one or more aspects disclosed herein. In one or more embodiments, computing resource(s) 120, and in particular, line management system 122, is in operative communication with one or more other data sources 130, such as one or more data sources providing ambient weather data 131 (such as temperature, precipitation windspeed, dew point, etc.) current alert data 132 (e.g., related to local weather alerts), video data of the overhead line 133, location data relating to the overhead line 134, historical data 135 (such as historical tensile related line data and/or weather data for the location of the overhead line). In one embodiment, the historical line-related data can be for the locations of the line sensor assemblies 110₁ . . . 110_{N} disbursed along the line, or throughout the grid containing one or more overhead lines. In one or more embodiments, computing resource(s) 120 can access one or more data sources 130 across network(s) 105 as well, or across one or more different networks.

By way of example, network(s) 105 can be, for instance, a telecommunications network, a local area network (LAN), a wide area network (WAN), such as the Internet, or a combination thereof, and can include wired, wireless, fiberoptic connections, etc. The network(s) can include one or more wired and/or wireless networks that are capable of receiving and transmitting data, including data packets. In one or more embodiments, the data includes data for implementing a line breakage prediction facility, system and process such as disclosed herein.

One embodiment of a computing environment to incorporate and use one or more aspects of the present invention is described with reference to FIG. 2. As an example, the computing environment is based on the IBM® z/Architecture® instruction set architecture, offered by International Business Machines Corporation, Armonk, N.Y. One embodiment of the z/Architecture instruction set architecture is described in a publication entitled, “z/Architecture Principles of Operation,” IBM Publication No. SA22-7832-12, Thirteenth Edition, September 2019, which is hereby incorporated herein by reference in its entirety. The z/Architecture instruction set architecture, however, is only one example architecture; other architectures and/or other types of computing environments of International Business Machines Corporation and/or of other entities may include and/or use one or more aspects of the present invention. z/Architecture and IBM are trademarks or registered trademarks of International Business Machines Corporation in at least one jurisdiction.

Referring to FIG. 2, a computing environment 200 includes, for instance, a computer system 202 shown, e.g., in the form of a general-purpose computing device. Computer system 202 can include, but is not limited to, one or more general-purpose processors or processing units 204 (e.g., central processing units (CPUs)), a memory 206 (a.k.a., system memory, main memory, main storage, central storage or storage, as examples), and one or more input/output (I/O) interfaces 208, coupled to one another via one or more buses and/or other connections. For instance, processors 204 and memory 206 are coupled to I/O interfaces 208 via one or more buses 210, and processors 204 are coupled to one another via one or more buses 211.

Bus 211 is, for instance, a memory or cache coherence bus, and bus 210 represents, e.g., one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

As examples, one or more special-purpose processors (e.g., neural network processors) (not shown) can also be provided separate from but coupled to the one or more general-purpose processors and/or can be embedded within the one or more general-purpose processors. Many variations are possible.

Memory 206 can include, for instance, a cache 212, such as a shared cache, which may be coupled to local caches 214 of processors 204 and/or to neural network processor, via, e.g., one or more buses 211. Further, memory 206 can include one or more programs or applications 216 and at least one operating system 218. An example operating system includes on IBM® z/OS® operating system, offered by International Business Machines Corporation, Armonk, N.Y. z/OS is a trademark or registered trademark of International Business Machines Corporation in at least one jurisdiction. Other operating systems offered by International Business Machines Corporation and/or other entities may also be used. Memory 206 can also include one or more computer readable program instructions 220, which can be configured to carry out functions of embodiments of aspects of the present invention.

Moreover, in one or more embodiments, memory 206 can include processor firmware (not shown). Processor firmware can include, e.g., the microcode or millicode of a processor. It can include, for instance, the hardware-level instructions and/or data structures used in implementation of higher level machine code. In one embodiment, it includes, for instance, proprietary code that is typically delivered as microcode or millicode that includes trusted software, microcode or millicode specific to the underlying hardware and controls operating system access to the system hardware.

Computer system 202 can communicate via, e.g., I/O interfaces 208 with one or more external devices 230, such as a user terminal, a tape drive, a pointing device, a display, and one or more data storage devices 234, etc. A data storage device 234 can store one or more programs 236, one or more computer readable program instructions 238, and/or data, etc. The computer readable program instructions may be configured to carry out functions of embodiments of aspects of the invention.

Computer system 202 can also communicate via, e.g., I/O interfaces 208 with network interface 232, which enables computer system 202 to communicate with one or more networks, such as a local area network (LAN), a general wide area network (WAN), and/or a public network (e.g., the Internet), providing communication with other computing devices or systems.

Computer system 202 can include and/or be coupled to removable/non-removable, volatile/non-volatile computer system storage media. For example, it can include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 202. Examples, include, but are not limited to: microcode or millicode, device drivers, redundant processing units, external disk drive arrays, RAID systems, tape drives, and data archival storage systems, etc.

Computer system 202 can be operational with numerous other general-purpose or special-purpose computing system environments or configurations. Examples of well-known computing systems, environments, and/or configurations that are suitable for use with computer system 202 include, but are not limited to, personal computer (PC) systems, mobile devices, GPS-based devices, handheld or laptop devices, server computer systems, thin clients, thick clients, multiprocessor systems, microprocessor-based systems, set top boxes, programmable consumer electronics, network PCs, minicomputer systems, mainframe computer systems, and distributed cloud computing environments that include any of the above systems or devices, and the like.

In one example, a processor (e.g., processor 204) includes a plurality of functional components (or a subset thereof) used to execute instructions. These functional components can include, for instance, an instruction fetch component to fetch instructions to be executed; an instruction decode unit to decode the fetched instructions and to obtain operands of the decoded instructions; one or more instruction execute components to execute the decoded instructions; a memory access component to access memory for instruction execution, if necessary; and a write back component to provide the results of the executed instructions. One or more of the components can access and/or use one or more registers in instruction processing. Further, one or more of the components may (in one embodiment) include at least a portion of or have access to one or more other components used in performing neural network processing (or other processing that can use one or more aspects of the present invention), as described herein. The one or more other components can include, for instance, a neural network processing assist component (and/or one or more other components).

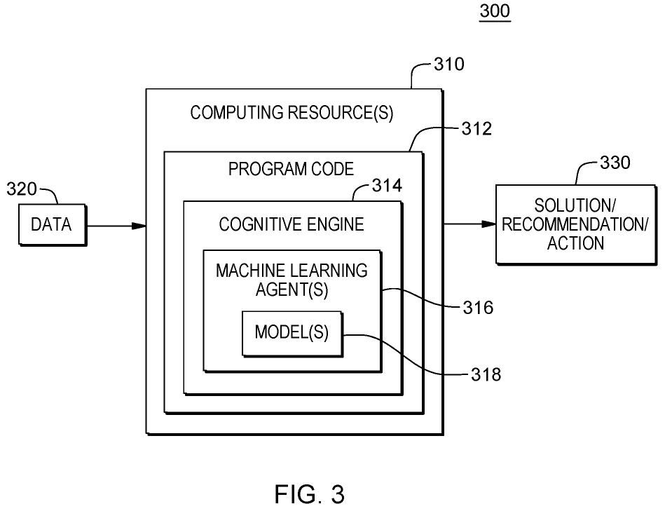

FIG. 3 depicts a further embodiment of a computing environment or system 300, incorporating, or implementing, certain aspects of an embodiment of the present invention. In one or more implementations, system 300 can be part of a computing environment, such as computing environment 100 described above in connection with FIG. 1 and/or computing environment 200 described above in connection with FIG. 2. System 300 includes one or more computing resources 310 that execute program code 312 that implements, for instance, a line management system, and includes a cognitive engine 314, which has one or more machine-learning agents 316, and one or more machine-learning models 318. Data 320, such as the data discussed herein, is used by cognitive engine 314, to train model(s) 318, to (for instance) predict an overhead line breakage probability, and to generate one or more solutions, recommendations, actions 330, etc., based on the particular application of the machine-learning model. In implementation, system 300 can include, or utilize, one or more networks for interfacing various aspects of computing resource(s) 310, as well as one or more data sources providing data 320, and one or more systems receiving the predicted line breakage probability and/or the output solution, recommendation, action, etc., 330 of machine-learning model(s) 318. By way of example, the network can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training data for the machine-learning model, predicted traffic event and an output solution, recommendation, action, of the machine-learning model, such as discussed herein.

In one or more implementations, computing resource(s) 310 houses and/or executes program code 312 configured to perform methods in accordance with one or more aspects of the present invention. By way of example, computing resource(s) 310 can be a cloud-based server, or other computing-system-implemented resource(s). Further, for illustrative purposes only, computing resource(s) 310 in FIG. 3 is depicted as being a single computing resource. This is a non-limiting example of an implementation. In one or more other implementations, computing resource(s) 310, by which one or more aspects of machine-learning processing such as discussed herein are implemented, could, at least in part, be implemented in multiple separate computing resources or systems, such as one or more computing resources of a cloud-hosting environment, by way of example.

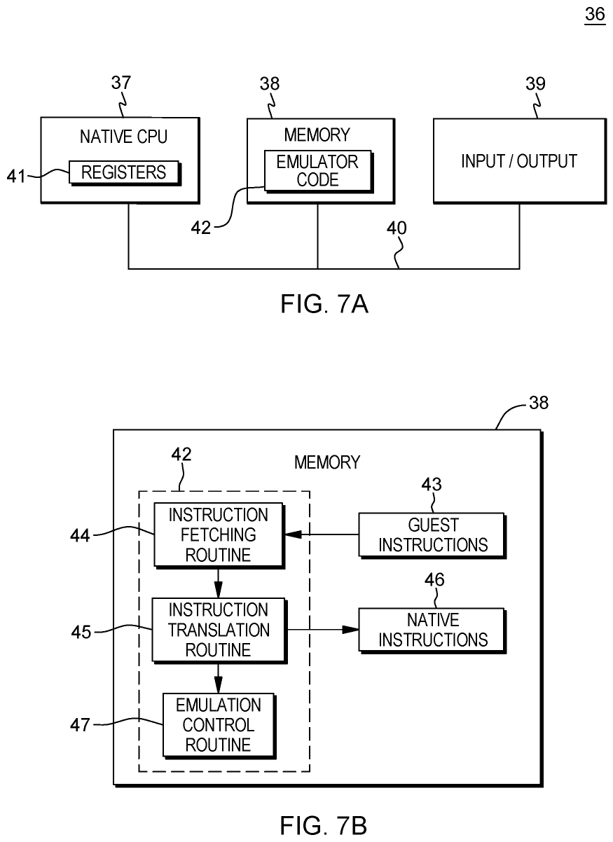

Briefly described, in one embodiment, computing resource(s) 310 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed herein are described further herein with reference to FIG. 2, as well as with reference to FIGS. 7A-9.

As noted, program code 312 executes, in one implementation, a cognitive engine 314 which includes one or more machine-learning agents 316 that facilitate training one or more machine-learning models 318. The machine-learning models are trained using training data that can include a variety of types of data, depending on the model and the data sources. In one or more embodiments, program code 312 executing on one or more computing resources 310 applies machine-learning algorithms of machine-learning agent 316 to generate and train the model(s), which the program code then utilizes to predict, for instance, a line breakage probability, and depending on the application, to perform an action (e.g., provide a solution, make a recommendation, perform a task, etc.). In an initialization or learning stage, program code 312 trains one or more machine-learning models 318 using obtained training data that can include, in one or more embodiments, network communication-related data associated with communications between servers of a network of a computing environment, such as described herein.

Training data used to train the model (in embodiments of the present invention) can include a variety of types of data, such as data generated by one or more sensors, devices or computer systems in communication with the computing resource(s). Program code, in embodiments of the present invention, can perform machine-learning analysis to generate data structures, including algorithms utilized by the program code to predict and/or perform a machine-learning action. As known, machine-learning (ML) solves problems that cannot be solved by numerical means alone. In this ML-based example, program code extract features/attributes from training data, which can be stored in memory or one or more databases. The extracted features are utilized to develop a predictor function, h(x), also referred to as a hypothesis, which the program code utilizes as a machine-learning model. In identifying machine-learning model 430, various techniques can be used to select features (elements, patterns, attributes, etc.), including but not limited to, diffusion mapping, principle component analysis, recursive feature elimination (a brute force approach to selecting features), and/or a random forest, to select the attributes related to the particular model. Program code can utilize a machine-learning algorithm to train machine-learning model (e.g., the algorithms utilized by program code), including providing weights for conclusions, so that the program code can train any predictor or performance functions included in the machine-learning model. The conclusions can be evaluated by a quality metric. By selecting a diverse set of training data, the program code trains the machine-learning model to identify and weight various attributes (e.g., features, patterns) that correlate to enhanced performance of the machine-learned model.

Some embodiments of the present invention can utilize IBM Watson® as learning agent. IBM Watson® is a registered trademark of International Business Machines Corporation, Armonk, N.Y., USA. In embodiments of the present invention, the respective program code can interface with IBM Watson® application program interfaces (APIs) to perform machine-learning analysis of obtained data. In some embodiments of the present invention, the respective program code can interface with the application programming interfaces (APIs) that are part of a known machine-learning agent, such as the IBM Watson® application programming interface (API), a product of International Business Machines Corporation, to determine impacts of data on the machine-learning model, and to update the model, accordingly.

In one or more embodiments, program code of the present invention can utilize and/or tie together multiple existing artificial intelligence (AI) applications, including, for instance, IBM® Weather Outage Prediction (part of the IBM Environmental Intelligence Suite), IBM® Operations Dashboard (with IBM cloud PAK for integration, and which is also part of the IBM Environmental Intelligence Suite), IBM® Maximo Asset Management (which is enterprise asset management software), and/or IBM® Digital Twin Exchange for the grid infrastructure (which is an enterprise-wide system for managing digital and physical assets). These, as well as other AI applications can be integrated and/or used by a line management system, which includes a machine learning model such as disclosed herein.

In some embodiments of the present invention, the program code utilizes a neural network to analyze training data and/or collected data to generate an operational model or machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present invention, can utilize in implementing a machine-learning model, such as described herein.

As noted, in one or more aspects, intelligent analytics is used herein to facilitate predicting a likelihood of line breakage, such as breakage of an electrical line. In one or more implementations, the line breakage prediction facility, system and process disclosed combine weather data, including historical weather data, with data on the state of the electrical line itself through which electricity flows. For instance, modeling tensile forces acting on a line and correlating those forces to current weather in the area facilitates providing a more accurate projection of when a weather event may cause breakage in the line. Advantageously, using line sensor assemblies such as disclosed herein including, in one or more implementations, Internet of Things (IoT) sensors, enables provision of an overhead line breakage prediction facility, system and process which can, in one or more implementations, reduce or eliminate restoration efforts, safety hazards, business delays or stoppages, reduce or eliminate carbon emissions, and keep business and society running smoothly without power interruption, by transitioning utilities from power restoration to outage prevention. Advantageously, the overhead line breakage prediction system disclosed herein allows utilities to collect information about the utility's power grids, including, areas of vulnerability, and to prepare well in advance of a severe weather forecast where one or more lines may be compromised or subject to breakage. In accordance with one or more aspects of the present invention, a utility can determine with a high degree of accuracy where the most likely location for a failure event is to occur, before it happens, and can also pinpoint an exact location of cable breakage when it does occur, enabling much quicker turnaround for the repair, significantly reducing the cost and resources required to restore service.

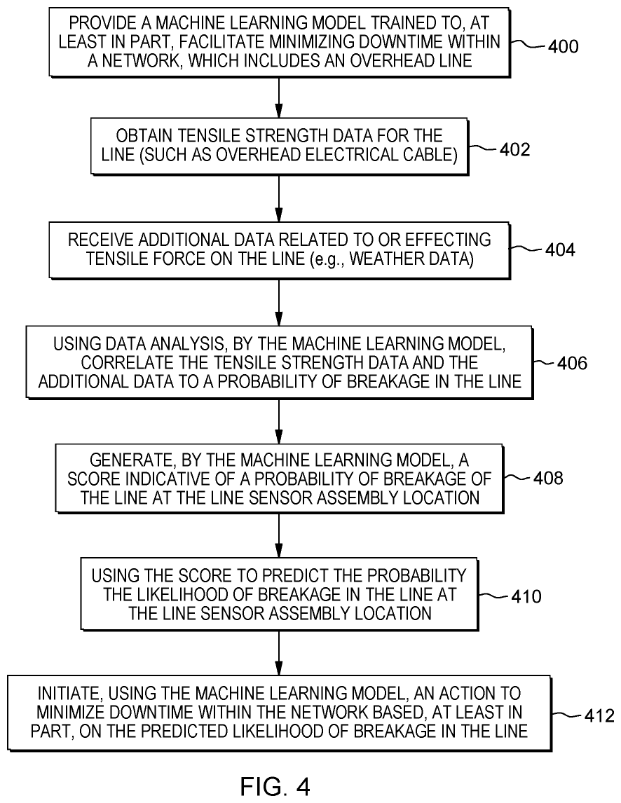

FIG. 4 depicts one embodiment of a workflow illustrating further certain aspects of some embodiments of the present invention. As illustrated in FIG. 4, in one or more aspects, a computer program product, computer system and computer-implemented method are provided, wherein program code executing on one or more processors includes, or provides, a machine learning model trained to, at least in part, facilitate minimizing downtime within a network, which includes an overhead line 400, and obtains tensile-related data for the overhead line, such as an overhead electrical line 402. In one or more embodiments, the program code obtains or receives additional data relating to or affecting tensile force on the line 404. This additional data can be obtained from any of a variety of data sources, such as described above in connection with FIG. 1. In one embodiment, the additional relevant data includes weather data for the area of the power line at issue. Data analytics is used, by the machine learning model, to correlate the tensile strength data and the additional data to a probability of breakage of the line 406. A score is generated by the machine learning model indicative of the probability of breakage of the line at the line sensor assembly location 408. The breakage score is used to predict the probability of likelihood of breakage in the line at the line sensor assembly location 410, and using the machine learning model, an action to minimize downtime within the network is initiated based, at least in part, on the predicted likelihood of breakage in the line 412.

In one or more embodiments, the action initiated can be, for instance, sending an automated message to a central system or central server when a probability of breakage score exceeds a specified threshold indicative of a likelihood of line breakage occurring, for instance, within a predefined time interval. In another embodiment, initiating the action can include, for instance, identifying a line breakage and initiating dispatching of a line crew to repair the line breakage, including, identifying the specific location of line breakage for the crew. In a further embodiment, initiating the action can include initiating heating of the line, where the line is provided with, or has associated therewith, an electrical heater (or electrical heating conductor(s)) to allow the system to automatically clear ice or snow from the line, where the probability of breakage score for the overhead line exceeds a specified threshold.

Note that in one or more other embodiments, the additional data obtained for the overhead line can include further data from a line sensor assembly associated with the line including, for instance, temperature data, humidity data and accelerometer data. In one implementation, the tensile-related data can include peak tension data for the overhead line for an interval of time, and the generating of the score can include generating the probability of breakage score for the overhead line using, at least in part, the peak tension data for the overhead line for the interval of time. In one embodiment, the program code can identify, based on the tensile-related data, whether there is currently a break in the overhead line, and based on the location of the line sensor assembly, can provide location of the break in the overhead line. In one implementation, the overhead line is an overhead electrical line, and the tensile-related data is obtained from a line sensor assembly coupled to the overhead line at a known location. As noted, initiating the action can include initiating an action to remove ice from the overhead line, such as by activating one or more electrical heating conductors associated with the overhead line to heat the overhead line to facilitate removing the ice.

By way of specific example, one or more aspects of the systems and methods disclosed herein can be enabled using, for instance, Internet-of-Things-enabled (IoT-enabled) tension sensors, together with additional sensors, such as humidity and/or temperature sensors, and correlating the sensed data to real-time weather data, enabling detection of tension variations on the cable as weather changes. The line sensor assemblies disclosed herein not only detect where a problem has occurred, but also where weakness in one or more lines may be developing. This is accomplished by detecting line stresses caused by various weather phenomenon, such as wind loads, icing loads, etc. Another common occurrence is galloping of the line, where wind-induced vibrations of a cable can involve extensive dynamic forces, breaking lines and sometimes leading to tower collapse. Using data gathered by a breakage prediction model such as disclosed herein, the system can predict with a high level of accuracy where a highest risk area for breakage resides in the grid. This allows a utility company to proactively address an issue as part of maintenance (typically under better weather conditions) rather than in response to an outage in inclement and dangerous weather.

Additionally, when a line break does occur, the line sensor assembly can provide a utility with pinpoint accuracy to where the line issue has occurred. Further, the sensors can provide information on estimating the amount of material that may be required to repair the issue. For instance, by detecting how many spans were impacted by a particular event, a work crew can know to bring, for instance, 1000 feet of line, even before being dispatched to the scene. Current processes rely heavily on manual inspection of failed lines, and often the utility only knows the general area where an outage has occurred, but not the specifics until a line person is sent out. Assessing repair needs prior to mobilization would assist the utility, and save time and money. As noted, a utility's traditional reactive approach to a line breakage costs money. In addition, utilities that over-mobilize for an event, spend money unnecessarily, and a utility that under-mobilizes, increases the estimated time of repair, which results in additional restoration expense and risk of customer dissatisfaction. With a higher estimated time of repair, regulators can impose financial penalties. It is not just the largest storms that have high costs. Smaller storms and more-routine seasonal weather events can add up over time. Therefore, a proactive approach that includes line sensor assemblies such as disclosed herein, reporting phenomenon about the grid lines themselves, can save a utility money. Empowering utilities in knowledge about their grids, without the expense of mobilizing resources, can improve the utility's bottom line while improving customer satisfaction.

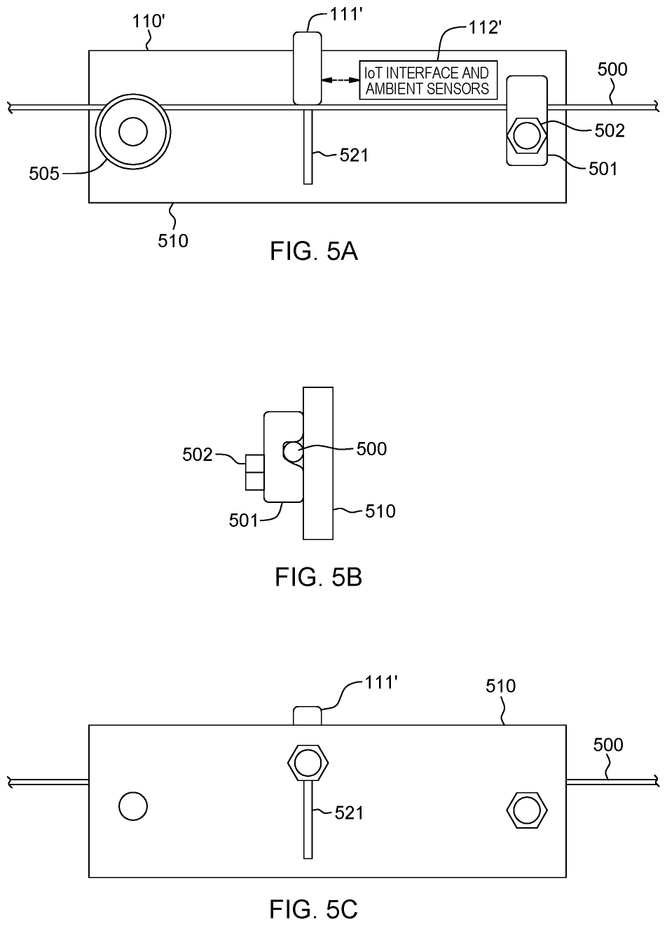

FIGS. 5A-5C depict one embodiment of a line sensor assembly 110′ for use in an overhead line breakage prediction system, such as disclosed herein. In one embodiment, line sensor assembly 110′ is affixed to a line, such as an electrical line of a utility grid at a known location. Referring collectively to FIGS. 5A-5C, line sensor assembly 110′ is coupled to a line 500 at one end using a clamp 501 and associated securing mechanism 502 which secures line 500 between clamp 501 and, for instance, a support plate 510, such as a metal support plate, or other rigid plate structure. The other end of line sensor assembly 110′ includes, for instance, a free-spinning wheel or pulley that allows line tension to change and be monitored by a tension sensor 111′. The position of tension sensor 111′ can be changed within a vertical groove 521 provided within support plate 510. In one embodiment, tension sensor 111′ is a load cell sensor that engages line 500, pressing slightly into the line, in order to monitor tension on the line. In the embodiment depicted, an electronic device, or Internet of Things (IoT) device 112′, is associated with line sensor assembly 110′, with the tension sensor 111′ shown in communication with IoT device 112′ via, for instance, an IoT interface. In one implementation, IoT device 112′ includes additional sensors, such as ambient sensors to sense, for instance, ambient temperature and humidity, as well as an accelerometer to provide further details on the condition of line 500. In one or more implementations, line sensor assembly 110′ can be installed on a line, such as an electrical line, without having to remove the cable or turn OFF power. The IoT device, or IoT interface device, is connected to the tension sensor for real-time data-gathering, and in one embodiment, a transmitter (such as a wireless transmitter) relays, for instance, encrypted sensor data to a remote data server, such as a remote cloud-based data server, for storage and analysis, such as described herein. In one or more embodiments, the frequency of data transmission can be adjustable remotely. In this manner, during good weather, sensor data can be collected (for instance) every few minutes, while during inclement weather and high gusts of wind, data collection can be adjusted to collect data, for instance, every few seconds.

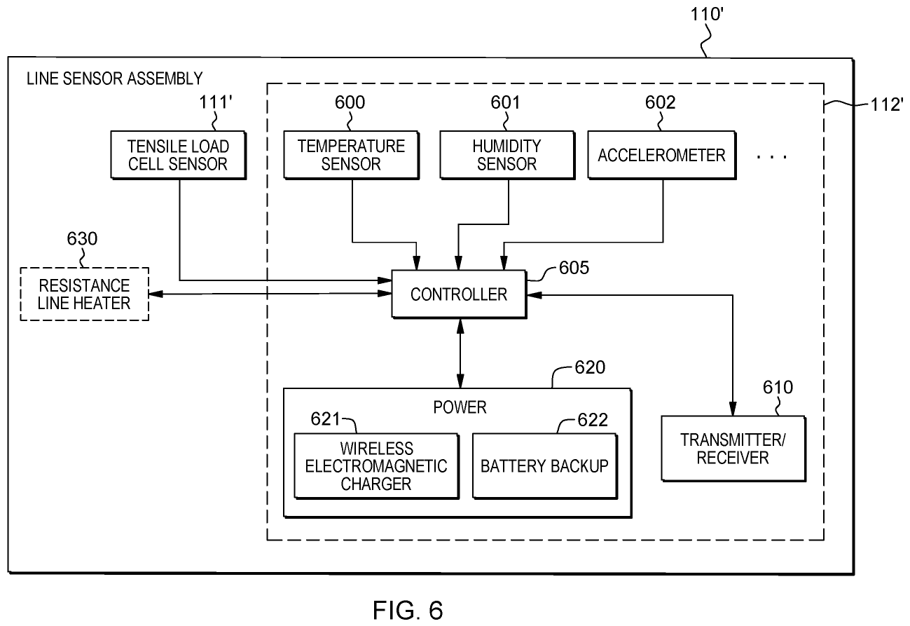

By way of further example, FIG. 6 is a schematic depiction of one embodiment of line sensor assembly 110′, in accordance with one or more aspects of the present invention. As noted, line sensor assembly 110′ includes a tension sensor or tensile load cell sensor 111′, and an IoT device 112′, with the tension sensor being in communication with the IoT sensor to allow the IoT device to collect tensile-related data from tension sensor 111′. In one embodiment, IoT device 112′ includes additional sensors, such as a temperature sensor 600, a humidity sensor 601, and an accelerometer 602, which provide additional sensor data to a controller 605 of IoT device 112′. Note that in one or more other embodiments, IoT device 112′ of line sensor assembly 110′ can include further additional sensors or fewer additional sensors, as desired. Controller 605 is in communication with a central system or server via a transmitter/receiver 610 associated with IoT device 112′. Further, a power supply 620 can be provided, in one embodiment, to power IoT device 112′, as well as tensile load sensor 111′. Power supply 620 can include, in one embodiment, a wireless electromagnetic charger 621, and a battery backup 622. In one implementation, wireless electromagnetic charger can implement wireless charging of IoT device 112′ via electromagnetic induction from the associated electrical line. The power requirements for the IoT device 112′ are low and can be derived from the electromagnetic field of the power line itself. For instance, a small coil included within the design of the clamp described in connection with FIGS. 5A-5C can gather sufficient power wirelessly from the line through inductive coupling. In addition, as noted, the IoT device can have a backup battery or capacitor power to maintain operation for 24 more hours, even where the power to the line is lost. This ability enables the device to provide important data in the event of a longer power outage. In one or more embodiments, the IoT device can use solar energy from a small solar panel attached to the IoT device to, for instance, recharge its backup battery.

As noted, in one or more embodiments, the tensile-related data, as well as the additional data obtained by the line sensor assembly, is encrypted and sent to a central server or system for processing such as described herein. The encrypted data can include, in one embodiment, sensor location data, a timestamp of the data, as well as, for instance, average and peak tension data since a prior reading. Peak tension data advantageously allows a more granular determination of high forces on the line that may affect breakage, and may not be apparent from an average tension reading.

As noted, in one or more embodiments, IoT device 112′ can contain one or more additional sensors for sensing temperature, humidity, etc., as well as a 3-axis accelerometer. This data can help identify exact forces acting on a line, and enable isolation of specific phenomenon, such as a line galloping, in addition to obtaining the tension-related data.

In one or more implementations, each line, or each line segment, can include an associated line sensor assembly which provides tensile-related data, as well as other data, such as described herein. In addition to data being collected by the line sensor assemblies, in one or more implementations, separate weather data collection is utilized and combined with the tensile-related data. For instance, weather data for different locations of the utility grid can be collected, such as temperature data, precipitation data, wind speed data, dewpoint data, etc.

In one or more implementations, the overhead line breakage prediction facility, system and computer-implemented method can be implemented by, for instance, a remote cloud-based machine learning model, which correlates the tensile-related data and weather datapoints and assigns a breakage score indicative of the risk of line breakage due to the effects of cable fatigue due to stresses experienced on the line (for instance, since installation). A simplified view of this, using sample wind speed and tension exerted to provide a simple illustration of a scenario would be:

| Measured | Measured | |
|---|---|---|
| Windspeed | Cable Tension | Score |
| 0 mph | 100 lbs. | 10 |
| 20 mph | 300 lbs. | 30 |
| 40 mph | 500 lbs. | 50 |
| 80 mph | 700 lbs. | 90 |
| 100 mph | 0 lbs. | 100 |

In one or more implementations, a machine learning model, such as described herein, can further consider additional input data, such as temperature and dewpoint data, to detect a potential ice formation, as well as repetitive stress that may weaken a line, etc. When a monitored line does experience an actual failure, the machine learning model can apply the data learned from the pattern that occurred before failure in order to more effectively determine other locations where future breaks might occur, and which are exhibiting a similar pattern.

As depicted in the example above, at 100 mph, the line already exceeded its rated breaking strength of 750 lbs., and failed, so that at that point, it does not exert any more line tension on the sensor. This allows the utility to instantly identify at which supporting structure(s) a line break occurred, how long the line breakage is, and exactly what conditions occurred leading to the break.

In addition to allowing accurate and specific predictions on when and where a line break may occur, data gathered by the sensors can also enable a utility to report to a cable manufacturer any anomalies in the line and obtain cable replacement under warranty when a breakage occurs without the cable being subjected to forces outside of specification. For instance, in the example above, if a recently installed cable encounters a breakage at 300 lbs. of tension when it is rated for 750 lbs., then the manufacturer can be provided the data, and the cable can be replaced without additional cost to the utility.

In one or more implementations, to prevent ice formation in known high-risk areas, such as near streams, or waterfalls, the system can be configured to preemptively activate a cable heating mechanism using a built-in electrical resistance heating conductor, or externally-applied heat tape. One example of this option is depicted as resistance line heater 630 in the line sensor assembly embodiment of FIG. 6. In one implementation, the overhead line breakage prediction system can automatically initiate heating of the associated line whenever, for instance, the probability of breakage score exceeds a specified threshold. Further, in order to save electricity, line heating can be turned ON and OFF by the system, such as by the IoT device of the line sensor assembly, to allow activating heating only when temperature is below freezing, and ice weight is detected on the cable. For instance, where ice is melting by the cable heat and cable tension returns to normal, heat can be turned OFF, even if temperature is still below freezing. If further icing forms, heat can then be turned ON automatically by the system, for instance, when tension on the line exceeds a specified threshold due to the ice.

As noted, data provided by the line sensor assemblies disbursed across different line segments of a grid can enable much more effective preventive maintenance and cost savings for a utility. For instance, if trending data shows a particular section of line icing, and projects that the line will reach a breaking point within the next two hours, it might cost the utility $1000 to send a crew out and remove the ice from the line within the next hour. Otherwise, if this is not done, and the cable breaks, it might cost $100,000 for the utility to send a crew to repair the breakage. In addition to saving costs, the predictive dispatching of a crew potentially eliminates loss of power for the utility's customers.

Other variations and embodiments are possible.

Another embodiment of a computing environment to incorporate and use one or more aspects of the present invention is described with reference to FIG. 7A. In this example, a computing environment 36 includes, for instance, a native central processing unit (CPU) 37, a memory 38, and one or more input/output devices and/or interfaces 39 coupled to one another via, for example, one or more buses 40 and/or other connections. As examples, computing environment 36 may include a Power® processor offered by International Business Machines Corporation, Armonk, N.Y.; an HP Superdome with Intel® processors offered by Hewlett Packard Co., Palo Alto, Calif.; and/or other machines based on architectures offered by International Business Machines Corporation, Hewlett Packard, Intel Corporation, Oracle, and/or others. PowerPC is a trademark or registered trademark of International Business Machines Corporation in at least one jurisdiction. Intel is a trademark or registered trademark of Intel Corporation or its subsidiaries in the United States and other countries.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture. For instance, emulator code 42 allows machines based on architectures other than the z/Architecture instruction set architecture, such as Power processors, HP Superdome servers or others, to emulate the z/Architecture instruction set architecture and to execute software and instructions developed based on the z/Architecture instruction set architecture.

Further details relating to emulator code 42 are described with reference to FIG. 7B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the z/Architecture instruction set architecture, but instead, are being emulated on native CPU 37, which may be, for example, an Intel processor. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

The computing environments described above are only examples of computing environments that can be used. Other environments, including but not limited to, non-partitioned environments, partitioned environments, cloud environments and/or emulated environments, may be used; embodiments are not limited to any one environment. Although various examples of computing environments are described herein, one or more aspects of the present invention may be used with many types of environments. The computing environments provided herein are only examples.

Each computing environment is capable of being configured to include one or more aspects of the present invention.

One or more aspects may relate to cloud computing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

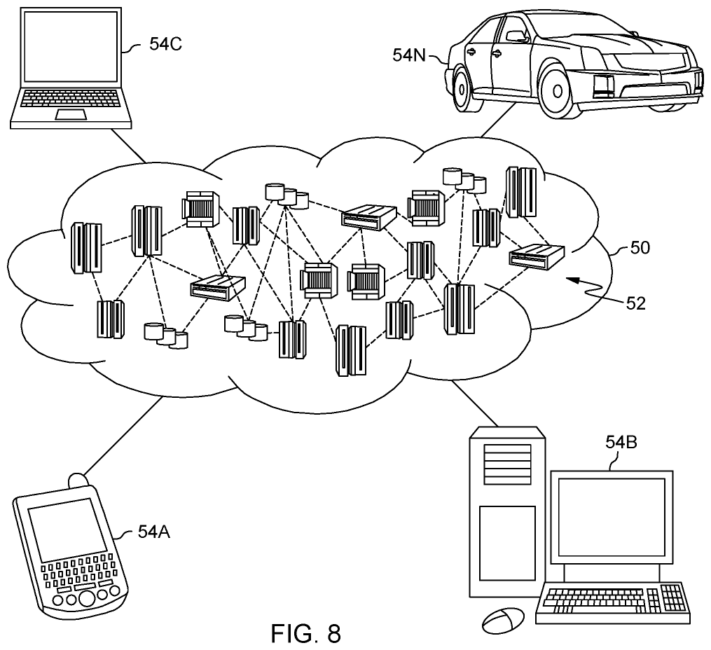

Referring now to FIG. 8, illustrative cloud computing environment 50 is depicted. As shown, cloud computing environment 50 includes one or more cloud computing nodes 52 with which local computing devices used by cloud consumers, such as, for example, personal digital assistant (PDA) or cellular telephone 54A, desktop computer 54B, laptop computer 54C, and/or automobile computer system 54N may communicate. Nodes 52 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 52 and cloud computing environment 50 can communicate with any type of computerized device over any type of network and/or network addressable connection (e.g., using a web browser).

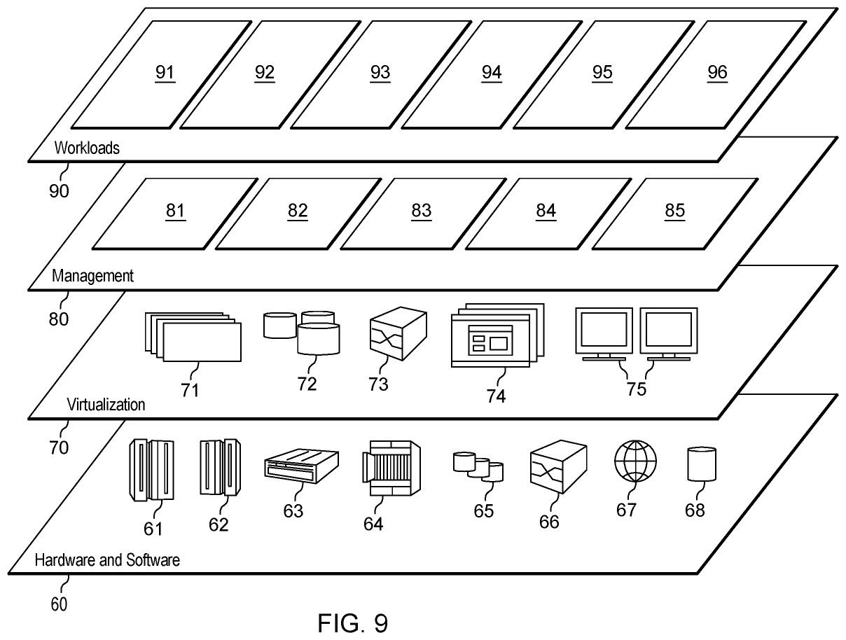

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and line breakage prediction processing 96.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For instance, computing environments of other architectures can be used to incorporate and/or use one or more aspects. Further, different instructions or operations may be used. Additionally, different types of registers and/or different registers may be used. Further, other data formats, data layouts and/or data sizes may be supported. In one or more embodiments, one or more general-purpose processors, one or more special-purpose processors or a combination of general-purpose and special-purpose processors may be used. Many variations are possible.

Various aspects are described herein. Further, many variations are possible without departing from a spirit of aspects of the present invention. It should be noted that, unless otherwise inconsistent, each aspect or feature described herein, and variants thereof, may be combinable with any other aspect or feature.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
at least one computer-readable storage medium having program instructions embodied therewith, the program instructions being readable by a processing circuit to cause the processing circuit to perform a method comprising:
providing a machine learning model trained to, at least in part, facilitate minimizing downtime within a network, the network including an overhead line;
obtaining tensile-related data for the overhead line;
analyzing, by the machine learning model, relevant data for the overhead line, including the tensile-related data for the overhead line, and generating by the machine learning model a probability of breakage score for the overhead line based on the relevant data, including the tensile-related data; and
initiating, using the machine learning model, an action to minimize downtime within the network based, at least in part, on the generated probability of breakage score for the overhead line.

2. The computer program product of claim 1, wherein the tensile-related data for the overheard line is for a geographical location, and the method further comprises:
obtaining weather data for the geographical location, wherein the generating includes generating the probability of breakage score of the overhead line using the tensile-related data and the weather data.

3. The computer program product of claim 1, further comprising:
obtaining additional data for the overhead line from a line sensor assembly coupled to the overhead line, the additional data being selected from the group consisting of temperature data, humidity data and accelerometer data; and
wherein the generating includes generating the probability of breakage score of the overhead line using the tensile-related data and the additional data.

4. The computer program product of claim 1, further comprising predicting, based on the probability of breakage score, a likelihood of breakage of the overhead line within a defined time interval.

5. The computer program product of claim 1, wherein the tensile-related data includes peak tension data for the overhead line for an interval of time, and the generating includes generating the probability of breakage score of the overhead line using, at least in part, the peak tension data of the overhead line for the interval of time.

6. The computer program product of claim 1, further comprising identifying, based on the tensile-related data, whether there is currently a break in the overhead line.

7. The computer program product of claim 1, wherein the overhead line is an overhead electrical line, and the tensile-related data is obtained from a line sensor assembly coupled to the overhead line at a known location.

8. The computer program product of claim 1, wherein initiating the action comprises initiating an action to remove ice from the overhead line.

9. The computer program product of claim 8, wherein initiating the action comprises initiating activating one or more electrical heating conductors associated with the overhead line to heat the overhead line to facilitate removing the ice.

10. A computer system for facilitating processing within a computing environment, the computer system comprising:
a memory;
a processing circuit in communication with the memory, wherein the computer system is configured to perform a method, the method comprising:
providing a machine learning model trained to, at least in part, facilitate minimizing downtime within a network, the network including an overhead line;
obtaining tensile-related data for the overhead line;
analyzing, by the machine learning model, relevant data for the overhead line, including the tensile-related data for the overhead line, and generating by the machine learning model a probability of breakage score for the overhead line based on the relevant data, including the tensile-related data; and
initiating, using the machine learning model, an action to minimize downtime within the network based, at least in part, on the generated probability of breakage score for the overhead line.

11. The computer system of claim 10, wherein the tensile-related data for the overheard line is for a geographical location, and the method further comprises:
obtaining weather data for the geographical location, wherein the generating includes generating the probability of breakage score of the overhead line using the tensile-related data and the weather data.

12. The computer system of claim 10, further comprising:
obtaining additional data for the overhead line from a line sensor assembly coupled to the overhead line, the additional data being selected from the group consisting of temperature data, humidity data and accelerometer data; and
wherein the generating includes generating the probability of breakage score for the overhead line using the tensile-related data and the additional data.

13. The computer system of claim 10, further comprising predicting, based on the probability of breakage score, a likelihood of breakage of the overhead line within a defined time interval.

14. The computer system of claim 10, wherein the tensile-related data includes peak tension data for the overhead line for an interval of time, and the generating includes generating the probability of breakage score of the overhead line using, at least in part, the peak tension data of the overhead line for the interval of time.

15. The computer system of claim 10, further comprising identifying, based on the tensile-related data, whether there is currently a break in the overhead line.

16. The computer system of claim 10, wherein the overhead line is an overhead electrical line, and the tensile-related data is obtained from a line sensor assembly coupled to the overhead line at a known location.

17. A computer-implemented method comprising:
providing a machine learning model trained to, at least in part, facilitate minimizing downtime within a network, the network including an overhead line;
obtaining tensile-related data for the overhead line;
analyzing, by the machine learning model, relevant data for the overhead line, including the tensile-related data for the overhead line, and generating by the machine learning model a probability of breakage score for the overhead line based on the relevant data, including the tensile-related data; and
initiating, using the machine learning model, an action to minimize downtime within the network based, at least in part, on the generated probability of breakage score for the overhead line.

18. The computer-implemented method of claim 17, wherein the tensile-related data for the overheard line is for a geographical location, and the method further comprises:
obtaining weather data for the geographical location, wherein the generating includes generating the probability of breakage score of the overhead line using the tensile-related data and the weather data.

19. The computer-implemented method of claim 17, further comprising:
obtaining additional data for the overhead line from a line sensor assembly coupled to the overhead line, the additional data being selected from the group consisting of temperature data, humidity data and accelerometer data; and
wherein the generating includes generating the probability of breakage score of the overhead line using the tensile-related data and the additional data.

20. The computer-implemented method of claim 17, further comprising predicting, based on the probability of breakage score, a likelihood of breakage of the overhead line within a defined time interval.
